(19) United States
(12) Patent Application Publication
(10) Pub. No.: US 2006/0251180 A1
(43) Pub. Date: Nov. 9, 2006

(54) METHOD AND SYSTEM FOR SELECTING MCS IN A COMMUNICATION NETWORK

(75) Inventors: Kevin L. Baum, Rolling Meadows, IL (US); Yufei W. Blankenship, Streamwood, IL (US); Brian K. Classon, Palatine, IL (US); Philippe J. Sartori, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/279,411

(22) Filed: Apr. 12, 2006

Related U.S. Application Data
(60) Provisional application No. 60/677,228, filed on May 3, 2005.

(51) Int. Cl. H04K 1/10

(52) U.S. Cl. 375/260

(57) ABSTRACT

A method for selecting an MCS for a carrier channel is provided. The method includes obtaining a set of characteristic parameters for a first function representing a variation of an effective SINR of the carrier channel with a calibration parameter; obtaining at least one of the effective SINR for a reference calibration parameter value and a band-average SINR; in one embodiment, translating the effective SINR for the reference calibration parameter value to a translated effective SINR for the calibration parameter value based on a second function; in another embodiment, translating the band-average SINR to the translated effective SINR for a calibration parameter value based on a third function if the band-average SINR is obtained; and selecting an MCS from a predefined MCS set for at least a portion of the carrier channel based on at least the translated effective SINR.

### FIELD OF THE INVENTION

The invention relates in general to the field of communication networks, and in particular to Modulation and Coding Scheme (MCS) selection in multi-carrier systems.

### BACKGROUND OF THE INVENTION

A multi-carrier communication system includes communication channels for multi-carrier communication. A communication channel is divided into multiple subcarriers. Examples of the multi-carrier system include, but are not limited to, an Orthogonal Frequency Division Multiplexed (OFDM) system, an Orthogonal Frequency Division Multiple Access (OFDMA) system, and the like.

For effective transmission of data in the multi-carrier system, the selection of an appropriate MCS is essential. Selecting a low order for the value of the MCS reduces errors in data transmission, but at the same time increases overheads and the cost of the data transmission. Selecting a high-order MCS may introduce errors in the data transmission.

The value of the MCS for the multi-carrier system depends on the Signal to Noise-plus-Interference Ratio (SINR) of the communication channel and on the SINR values of the individual subcarriers constituting the channel. One of the methods for MCS selection that makes use of the SINR values of individual subcarriers is the Exponential Effective SIR Mapping (EESM) method. In the EESM method, an effective SINR is computed as a function of the SINR values of the individual subcarriers and a calibration parameter.

However, to select the best MCS, a large amount of information exchange has to take place between a Subscriber Station (SS) and a Base Station (BS), which results in large overhead.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary environment in which various embodiments of the present invention can be practiced.

FIG. 2 is a flowchart illustrating a method for selecting a Modulation and Coding Scheme (MCS), in accordance with an embodiment of the present invention.

FIG. 3 is a flowchart illustrating a method for selecting the MCS, in accordance with another embodiment of the present invention.

FIG. 4 is a flowchart illustrating a method for assisting MCS selection, in accordance with an embodiment of the present invention

FIG. 5 is a flowchart illustrating a method for assisting MCS selection, in accordance with another embodiment of the present invention

FIG. 6 is a block diagram of an exemplary Subscriber Station (SS), in accordance with an embodiment of the present invention.

FIG. 7 is a block diagram of an exemplary Base Station (BS), in accordance with an embodiment of the present invention.

FIG. 8 is a flow chart illustrating a method for assisting MCS selection, in accordance with an embodiment of the present invention.

FIG. 9 is a flow chart illustrating a method for assisting MCS selection, in accordance with an embodiment of the present invention.

FIG. 10 illustrates the effect of scaling and of shifting an SNR_{eff} versus β_{dB} curve.

FIG. 11 illustrates the curves of Eₛ/N₀=3 dB and 10 dB from FIG. 10.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular method and system for selecting a Modulation and Coding Scheme (MCS) for at least a portion a carrier channel in accordance with the present invention, it should be observed that the present invention resides primarily in combinations of method steps and system components related to selecting the MCS for the at least portion of the carrier channel.

Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element. The terms ‘Signal to Interference-plus-Noise Ratio (SINR)’, ‘Carrier to Interference-plus-Noise Ratio (CINR)’ and ‘Signal to Noise Ratio (SNR)’ are used as synonyms.

The present invention describes a method and system for selecting a Modulation and Coding Scheme (MCS) at a communication unit for at least a portion of a carrier channel that includes a plurality of subcarriers. The method includes obtaining a set of characteristic (or model) parameters for a first function representing a variation of an effective signal to noise-plus-interference ratio (SINR) of the carrier channel with a calibration parameter (β). The set of characteristic parameters is based on at least one of a predefined and measured characteristics of the carrier channel. The method includes obtaining an effective SINR (SINR_{eff}) for a reference calibration parameter value. The method further includes translating the effective SINR for the reference calibration parameter value to a translated effective SINR for a calibration parameter value that differs from the reference calibration parameter value, based on a second function. The second function is equivalent to a two-dimensionally shifted version of the first function when viewed in a log domain. Moreover, the method includes selecting an MCS from a predefined MCS set for the at least one portion of the carrier channel based on at least the translated effective SINR.

The present invention also describes an additional embodiment of a method and system for selecting a Modulation and Coding Scheme (MCS) at a communication unit for at least a portion of a carrier channel that includes a plurality of subcarriers. The method includes obtaining a set of characteristic (or model) parameters for a first function representing a variation of an effective signal to noise-plus-interference ratio (SINR) of the carrier channel with a calibration parameter (β). The set of characteristic parameters is based on at least one of a predefined and measured characteristics of the carrier channel. The method includes obtaining a band-average SINR (SINR_{band}). The SINR_{band} represents an average of SINR values for a plurality of subcarriers within the carrier channel. The method includes translating the band-average SINR to a translated effective SINR for a particular calibration parameter value based on a third function of at least the band-average SINR and the characteristic parameters. Moreover, the method includes selecting an MCS from a predefined MCS set for the at least one portion of the carrier channel based on the at least translated effective SINR.

The present invention also describes a method for assisting modulation and coding scheme (MCS) selection for at least a portion of a carrier channel, the carrier channel comprising a plurality of subcarriers. The method includes determining a set of characteristic parameters for a first function representing a variation of an effective SINR of the carrier channel with a calibration parameter. The set of characteristic parameters is computed based on a plurality of measurements of the carrier channel at different time instances. The method includes transmitting the set of characteristic parameters to a second communication unit. The method further includes transmitting at least one of an effective SINR for a reference calibration parameter value and a band-average SINR to the second communication unit to assist with MCS selection by the second communication unit.

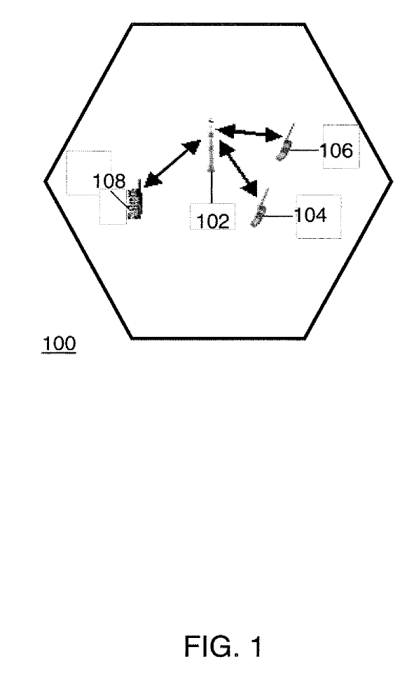

FIG. 1 illustrates an exemplary environment in which various embodiments of the present invention can be practiced. The environment includes communication units 102, 104, 106, and 108 in a multi-carrier system. It will be apparent to a person ordinarily skilled in the art that the communication units can be a combination of base station (BS) and subscriber stations (SSs). For the purpose of this description, the communication unit 102 is a BS and communication units 104, 106 and 108 are SSs. Examples of multi-carrier systems include Orthogonal Frequency Division Multiplexed (OFDM) systems and Orthogonal Frequency Division Multiple Access (OFDMA) systems. The multicarrier system has multiple subcarriers that make up a carrier channel, allowing data transmission between the BS 102 and the SSs 104, 106 and 108. The subcarriers are used to carry data symbols and optionally occasional pilot symbols to support coherent channel estimation, SINR estimation, and coherent detection of the data. Though for exemplary purposes, the environment is shown to comprise only three SSs 104, 106, and 108 and one BS 102, it would be apparent to a person skilled in the art that the invention can be practiced with one or more SSs and one or more BSs. Moreover, it would be apparent to a person ordinarily skilled in the art that the invention can be practiced with communication units that are not necessarily a BS or a SS, such as communication units performing peer-to-peer or point-to-point communication, etc.

To transmit data between the BS 102 and a SS, for example, the SS 104 through the carrier channel, a MCS needs to be selected for the subcarriers within the carrier channel that are used for the data transmission. Exemplary values of the MCS can be rate 1/2 coded QPSK, un-coded 64 QAM and rate ¾ coded 16-QAM. The MCS for the multi-carrier system depends on an Effective Signal to Noise-plus-Interference Ratio (SINR_{eff}) of the carrier channel, which, in turn, depends on individual SINRs of the subcarriers of the carrier channel. The term SINR as used herein is intended to encompass any of various known signal quality indicators such as the already stated signal to noise-plus-interference ratio or similar quality indicators such as signal-to-noise ratio, signal-to-distortion ratio, desired signal level, channel gain, received signal strength, received log-likelihood ratio, and so forth. A SINR_{eff} is an equivalent static channel SINR, for which the corresponding MCS has a frame error rate (FER), which is equal or approximately equal to the FER in the carrier channel. According to the Exponential Effective SIR Mapping (EESM) method (SIR refers to Signal-to-Interference Ratio), the SINR_{eff} is given by:

$${SINR}_{eff} = EESM ( \{ {γ}_{1} , … , {γ}_{N} \} , β ) = - β \cdot ln ( \frac{1}{N} {\sum }_{i = 1}^{N} exp ( - \frac{{γ}_{i}}{β} ) ) \qquad ( 1 )$$

where N is the number of subcarriers in the carrier channel used to evaluate SINR_{eff}, β is a calibration parameter that is typically different for different MCS values, and {γ₁, . . . γ_{N}} are the SINR values of the subcarriers of the carrier channel used to evaluate SINR_{eff}. Other frequency selective link error prediction methods may be used to determine an effective SINR, such as Mutual Information Effective SINR Mapping (MIESM) or Capacity Effective SINR Mapping (CESM). The subcarriers used for evaluating SINR_{eff} may be the same as or different from the subcarriers used for a subsequent data transmission to the SS 104, but it is preferable that the subcarriers used for evaluating SINR_{eff} provide information related to or similar to the SINR_{eff} that would be obtained by evaluating the subcarriers to be used for the subsequent data transmission. The effective SNR may also be evaluated on groups of subcarriers (also known as subchannels or bins), where the subcarrier SINR values are group of subcarrier SINR values. Embodiments of the present invention pertain to the MCS selection, preferably for short term or fast link adaptation by using the EESM method. In short-term link adaptation, the frequency response of the carrier channel is not expected to change drastically between the time it is measured and the time of a transmission, by using an MCS that has been selected, based on the time the measurement was taken.

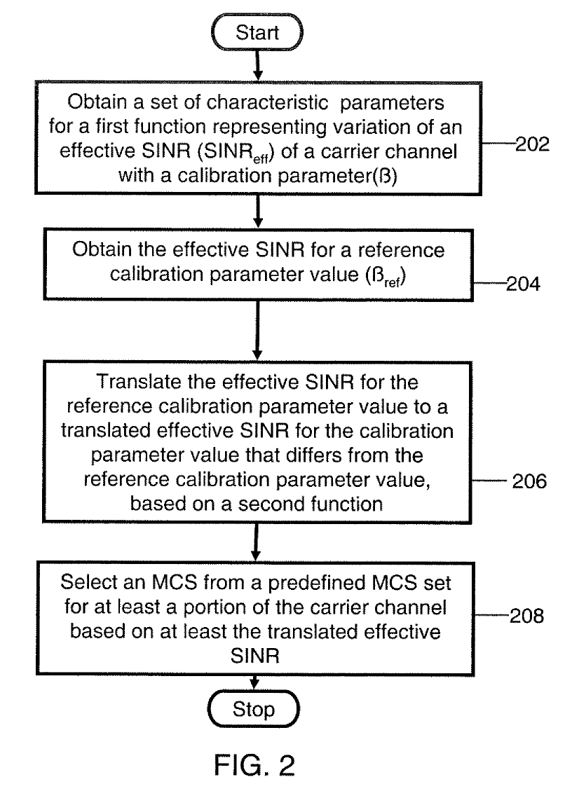

FIG. 2 illustrates a flowchart showing a method for selecting the MCS, in accordance with an embodiment of the present invention. At step 202, a set of characteristic parameters is obtained for a first function. The first function represents a variation of the SINR_{eff} of the carrier channel with the β. The set of characteristic parameters is based on at least one of predefined condition and measured condition of the carrier channel. In an embodiment of the present invention, the form of the first function (linear, quadratic, polynomial, exponential, etc.) is known in advance to the BS 102 and the SS 104 (e.g., based on a communication protocol specification). In another embodiment of the present invention, the form of the first function may be known only to either the BS 102 or the SS 104. In yet another embodiment, the first function may be changed over time. The first function can be any known function, such as a linear function, a quadratic function, etc., and the set of characteristic parameters specify the coefficients or parameters of the first function. For example, the first function can be a quadratic function of the form
SINR_{eff}≅a+bβ+cβ²,

where a, b, and c represent the characteristic parameters and where SINR_{eff} and β are in dB units. In one embodiment, the characteristic parameters (e.g., a, b, c in the above quadratic function) are obtained directly. In another embodiment, the characteristic parameters are obtained indirectly, such as from two out of three of a, b, and c and an SINR_{eff} value for an assumed or predetermined β value (e.g., a=SINR_{eff}−bβ−cβ² if b, c, and SINR_{eff} for β=1 are known).

The set of characteristic parameters that are obtained are based on measured and/or predefined conditions of the carrier channel. In an embodiment, the SS 104 measures the condition of the carrier channel by evaluating the SINR of each of a plurality of subcarriers of the carrier channel at one or more time instants (e.g., based on one or more measurements), and determines characteristic parameters such that the first function approximates the variation of SINR_{eff} with β. Values of SINR_{eff} for various β can be obtained using equation (1), and these values can be used as reference values that the first function is attempting to match or approximate (e.g., using standard curve fitting techniques).

The measured condition of the carrier channel preferably comprises SINR values for a plurality of subcarriers within the carrier channel. The SINR values for a plurality of subcarriers of the carrier channel are preferably determined based on a plurality of SINR values for a plurality of pilot-carrying subcarriers, but other methods such as decision aided or received-signal strength methods, etc. could also be used. There are various ways in which the SINR values of the subcarriers can be determined. Some examples include, but are not limited to, estimating a channel magnitude for one or more of the subcarriers and dividing each of the channel magnitudes by an estimated noise and interference power for the carrier channel, estimating a channel magnitude for one or more of the subcarriers and dividing each of the channel magnitudes by a corresponding estimated noise and interference power for the corresponding subcarrier, and estimating a channel magnitude for one or more of the subcarriers and dividing each of the channel magnitudes by a an assumed reference noise and interference power. In another case, the reference noise is taken as one and the division is not necessary.

Further, one or more time instants may be used when evaluating the SINR of each of a plurality of subcarriers of the carrier channel. For example, when only one time instant is used, the time instant may correspond to either a current received signal (e.g., the currently received OFDM symbol), a recently received signal (e.g., a recently received OFDM symbol), or a received signal that was not recently received (e.g., an OFDM symbol received several frames earlier). When a plurality of time instants (different time instants) is used, they may correspond to any combination of current and/or previous time instants. When a plurality of time instants is used, there are various methods that the SS 104 can use to determine the characteristic parameters. In an embodiment, an average SINR for a sub carrier is determined, for example, by averaging the SINR of a subcarrier over the plurality of time instants before using the average SINR in the computation of SINR_{eff}. In another embodiment, SINR values from different subcarriers at different time instants are used in the computation of SINR_{eff}, such as curve averaging, wherein an SINR_{eff} vs. β curve is determined for each of the plurality of time instants (e.g., based on either equation 1 at each of the time instants or based on the set of characteristic parameters determined for each of the time instants), and the curves are averaged to provide an averaged SINR_{eff} vs. β curve. The set of characteristic parameters are then based on the averaged SINR_{eff} vs. β curve. The averaging is preferably performed with the SINR_{eff} of the curves represented in dB units. In another embodiment, at each considered value of β, the SINR_{eff} value at that β value from each of the curves is averaged to provide an averaged SINR_{eff} value for each of the β values, thus providing an averaged curve. Other types of averaging can also be used, such as the averaging of the set of characteristic parameters rather than curves, or averaging a function representing each curve. Moreover, the number of curves to be averaged and the weight assigned to each curve in the averaging process can optionally be varied based on the Doppler and/or delay spread of the channel (e.g., at very low Doppler, more weight could be given to curves from the most recent time instants, or at low delay spread a more uniform weight and/or a larger number of curves could be used). Methods based on averaging over a plurality of measurements can be described as determining an average characteristic or an ensemble average set of characteristic parameters.

In yet another embodiment, the set of characteristic parameters is selected from a plurality of measurements at previous time instants. For example an SINR_{eff} VS. β curve may be determined for each of the plurality of time instants (e.g., based on either equation 1 at each of the time instants or based on the set of characteristic parameters determined for each of the time instants). A curve that preferably is near the middle of all the curves is selected and the set of characteristic parameters are based on the selected curve. Moreover, the selection of the time instant to be used for determining the characteristic parameters may optionally depend on a delay spread and/or Doppler measurements of the carrier channel. For example, if the Doppler measurement is very low, the curve corresponding to the most recent time instant may provide better performance than the curve that lies near the middle of all the curves. In another example, if the delay spread is very low, then it may be beneficial to select a curve that is near the middle of all the curves and determine the characteristic parameters based on the selected curve.

In an embodiment, the set of characteristic parameters are obtained by the BS 102 by receiving the set of characteristic parameters from a second communication unit, such as SS 104. In this embodiment, the SS 104 determines the set of characteristic parameters for the first function and transmits the set of characteristic parameters to the BS 102.

When the set of characteristic parameters that are obtained are based on the predefined conditions of the carrier channel, the BS 102 has one or more predefined sets of characteristic parameters for the first function corresponding to one or more predefined conditions of the channel. In an embodiment, a single set of characteristic parameters is stored in the BS 102 and the set of characteristic parameters are obtained by retrieving them from memory. In this case the stored set of characteristic parameters was preferably designed to provide a reasonable approximation of the variation of SINR_{eff} with β for typical or expected channel conditions. In another example, to provide improved accuracy, there may be a plurality of predefined channel conditions, such as low delay spread, medium delay spread, and high delay spread. The BS 102 can determine the predefined channel characteristic that is closest to the current condition of the carrier channel (this channel classification process can optionally use the measured SINR values of subcarriers to assist with the classification decision), and then select or obtain the set of characteristic parameters corresponding to that predefined channel condition. In this case, obtaining the set of characteristic parameters may comprise either retrieving the appropriate characteristic parameters from memory or receiving an indication of the set of characteristic parameters from the SS 104.

At step 204, the effective SINR for a reference calibration parameter value (β_{ref}) is obtained. In one embodiment, this effective SINR is transmitted by SS 104 and received or obtained by BS 102. In an embodiment of the present invention, the value of the β_{ref} is selected by the SS 104. The β_{ref} value corresponds to a preferred reference point for computing the set of characteristic parameters. The β_{ref} value may also be a predetermined value, for example, a value defined in a system specification. The β_{ref} value may also be determined and/or changed dynamically, or the predetermined value can be chosen to enhance the accuracy/performance of data transmission. For example, the reference calibration parameter value may be chosen to be between a first calibration parameter value associated with a first MCS of a predefined MCS set, and a second calibration parameter value associated with a second MCS of the predefined MCS set. The β_{ref} value may be selected from a predefined table that includes a predefined MCS set and its corresponding β values. In an exemplary embodiment of the present invention, the predefined MCS set includes all the applicable MCS values. In one case, the value of the β_{ref} that is selected corresponds to the value that lies in the middle of the predefined MCS set. In another exemplary embodiment of the present invention, the β_{ref} value is selected from a set of calibration parameters. The set of calibration parameters corresponds to the MCS values that were used for data transmissions in some previous frames. In one case, the value of the β_{ref} selected corresponds to the value that lies in the middle of the set of calibration parameters. In one embodiment, once the β_{ref} value is selected, the SS 104 transmits the set of characteristic parameters, the SINR_{eff} for the β_{ref}, and the β_{ref} value that has been selected, to the BS 102. In another embodiment of the present invention, the value of the β_{ref} is known to both the BS 102 and the SS 104. In other words, the β_{ref} has a predefined value. In this case, the SS 104 can transmit the SINR_{eff} for the β_{ref} value.

In an embodiment of the present invention, the SINR_{eff} is obtained (e.g., determined by BS 102, or transmitted by SS 104) on a frame-by-frame basis, or for each frame, for short-term link adaptation. However, the set of characteristic parameters are obtained, for example, only when channel conditions change considerably. For example, at the beginning of a communication session, the characteristic parameters and possibly also the SINR_{eff} could be obtained and then the SINR_{eff} could be obtained afterwards without obtaining a new set of characteristic parameters. For example, the set of characteristic parameters may not need to be obtained again as long as a power delay profile of the carrier channel does not change significantly.

At step 206, the effective SINR obtained for the reference calibration parameter value is translated to a translated effective SINR for a calibration parameter (β) value that differs from the reference calibration parameter value. The translation is based on a second function. A possible operational scenario for this invention is that the effective SINR will be transmitted by SS 104 to BS 102 frequently, such as once per frame, but the set of characteristic parameters will be updated or obtained less frequently, such as once every several frames. In this scenario, the characteristic parameters for the first function can be used to provide an SINR_{eff} vs. β curve that passes through the point (β_{ref}, SINR_{eff}), where β_{ref} and SINR_{eff} are the reference β value and the effective SINR value, respectively, corresponding to the characteristic parameters currently being used. However, when a new SINR_{eff} is reported by SS 104 without updating the characteristic parameters, the SINR_{eff} vs. β curve needs to be translated so that it passes through or close to the new SINR_{eff} value at the reference β value. The effective SINR is known for a particular value of β, and the effect of a positive scale factor a being applied to each SINR value in the EESM equation (1) has to be considered. Before scaling by a, the SINR vector can be represented as {γ₁, . . . , γ_{N}}. After scaling by a (in linear domain) the SINR vector becomes {aγ₁, . . . , aγ_{N}} in a linear domain. Thereafter, the variation of the SINR_{eff} with β for the scaled vector is obtained by substituting the scaled vector for the original vector in equation (1). The variation of the SINR_{eff} with β for the scaled vector is related to the variation of the SINR_{eff} with β for the original vector as follows:

$$\begin{matrix}EESM ( \{ a {γ}_{1} , … , a {γ}_{N} \} , β ) = - β \cdot ln ( \frac{1}{N} {\sum }_{i = 1}^{N} exp ( - \frac{a {γ}_{i}}{β} ) ) \\ = a [ - \frac{β}{a} \cdot ln ( \frac{1}{N} {\sum }_{i = 1}^{N} exp ( - \frac{{γ}_{i}}{β / a} ) ) ] \\ = a \times EESM ( \{ {γ}_{1} , … , {γ}_{N} \} , β / a )\end{matrix} \qquad ( 2 )$$

When SINR_{eff} and β are expressed in dB, equation (2) becomes
EESM_{dB}({aγ₁, . . . , aγ_{N}}β_{dB})=a_{dB}+EESM_{dB}({γ₁, . . . , γ_{N}}, β_{dB}−a_{dB}) (3)

where a_{dB}=101 log₁₀a, and EESM_{dB} is expressed as a function of β_{dB}. Based on equation (3), an SINR_{eff} vs. β curve can be obtained for a scaled SINR vector by performing a two dimensional translation of the SINR_{eff} vs. β curve for the un-scaled SINR vector, when viewed in dB or the log domain. The two-dimensional translation is preferably by similar magnitudes on both the β and SINR_{eff} axes, since the same value a_{dB} appears in both dimensions in the EESM equation (3). When a new effective SINR value is obtained but the set of characteristic parameters and the reference β value are not changed, the difference (in dB) between the new effective SINR value and the effective SINR value associated with the set of characteristic parameters can be used to determine the value of a_{dB}. Thereafter, the set of characteristic parameters for the first function together with the values of the shifting in each dimension can be used as a second function to translate the newly obtained SINR_{eff} for the reference calibration parameter value to a translated SINR_{eff} value for any other value of β. As a result, the second function is equivalent to or characterized by a two-dimensionally shifted version of the first function when viewed in a log domain, and the output of the second function is substantially close to the effective SINR for the reference calibration parameter value when the input to the second function is the reference calibration parameter value.

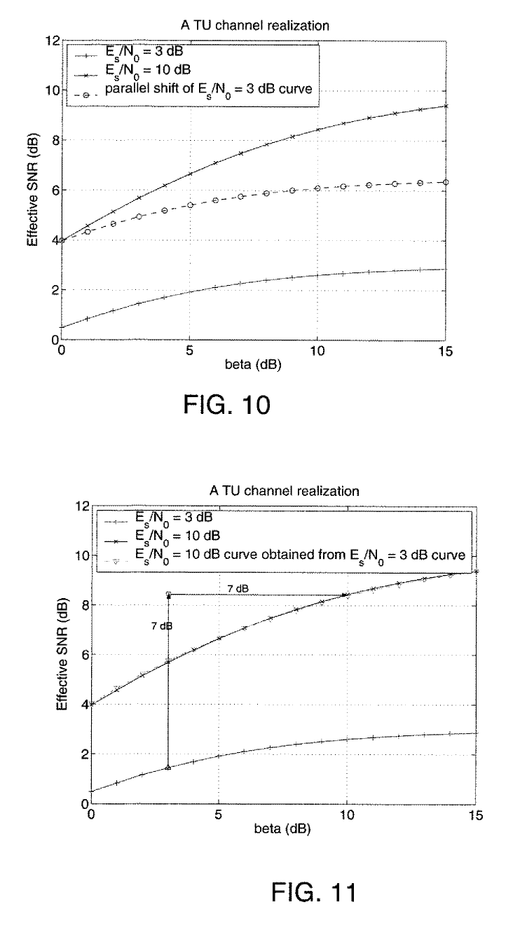

FIG. 10 shows the effect of scaling and of shifting an SNR_{eff} versus β_{dB} curve. In FIG. 10, a GSM Typical Urban (TU) channel realization is used as an example to show the error of using the simple curve shift approach to obtain the EESM_{db}({aγ₁, . . . , aγ_{N}}, β_{dB}) vs. β_{dB} curve from a EESM_{dB}({γ₁, . . . , γ_{N}},β_{dB}) vs. β_{dB}. In FIG. 10, the EESM_{dB} curve is shown for channel Eₛ/N₀=3 dB and 10 dB. A parallel shift of the Eₛ/N₀=3 dB curve (i.e., the simple curve shifting method) is also shown. Comparing the parallel shifted curve and the Eₛ/N₀=10 dB curve, it is clear that if the parallel shifted Eₛ/N₀=3 dB curve is used to approximate the Eₛ/N₀=10 dB curve, then significant error would occur.

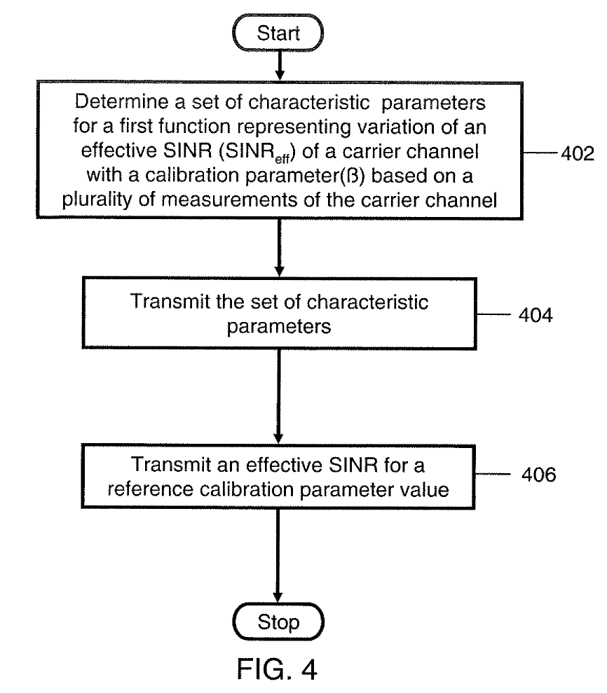

In FIG. 11, the curves of Eₛ/N₀=3 dB and 10 dB from FIG. 4 are included. A third curve is obtained using the relationship in equation (3) together with a polynomial approximation of the Eₛ/N₀=3 dB curve. This shows that relationship in equation (3) can be used to obtain an exact curve of EESM_{dB}({aγ₁, . . . ,aγ_{N}}, β_{dB}) vs. β_{dB} curve from a EESM_{dB}({γ₁, . . . ,γ_{N}}, β_{dB}) vs. β_{dB} curve.

At step 208, the MCS value is selected for the at least one portion of the carrier channel at the BS 102, based on the translated effective SINR. The MCS is selected from the predefined set of MCS values. For example, an MCS may be selected such that an acceptable frame error rate (FER) is likely to be obtained. In an embodiment, an MCS corresponding to a calibration parameter value, at whose translated effective SINR the FER is less than a target FER, can be selected. In one embodiment, the value of the MCS that is selected preferably has a FER that is lower than (or alternatively, close to) a target FER. Further, if there are more than one MCS values for which the FERs are less than the target FER, then the maximum MCS value amongst the MCS values having the corresponding FER less than, (or alternatively, close to) a target FER is preferably chosen. In order to select the best MCS, it is preferable to generate a plurality of translated effective SINR values, such as a translated effective SINR value for each β value corresponding to an available MCS. Each MCS may have a corresponding calibration parameter value and a corresponding translated SINR_{eff} value for a particular target FER. In other embodiments, additional factors can be taken into account when selecting the MCS, such as an expected amount of channel variation in a time period, Doppler, the number of retransmissions possible in the system (e.g., in a hybrid ARQ scheme), the robustness of the application to errors and/or delays, expected changes in interference, noise, or signal levels, channel conditions, etc. In one embodiment, after selecting the MCS, data is modulated and coded based on the selected MCS and is then transmitted.

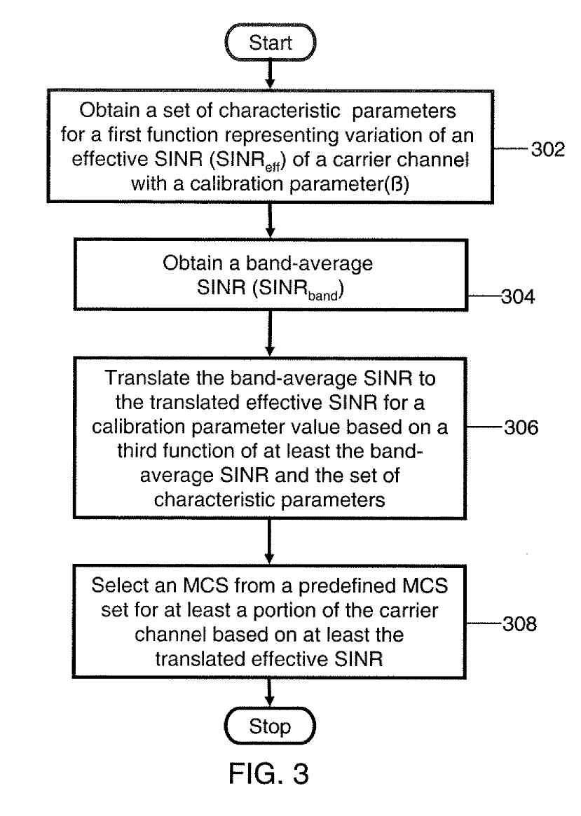

FIG. 3 is a flowchart illustrating a method for selecting the MCS, in accordance with another embodiment of the present invention. At step 302, a set of characteristic parameters is obtained for a first function as explained in detail in conjunction with FIG. 2.

At step 304, a band-average SINR (SINR_{band}) is obtained. The band-average SINR represents an average of SINR values for a plurality of subcarriers within the carrier channel. In an embodiment, SINR_{band} is obtained by BS 102 from SS 104 (SS 104 transmits the value of SINR_{band} and it is received by BS 102). In another embodiment, SINR_{band} is determined by the BS 102. The plurality or set of subcarriers may or may not include all the subcarriers of the carrier channel. For example, the SINR_{band} can be determined as:

$${SNR}_{band} = \frac{1}{N} {\sum }_{i = 1}^{N} {γ}_{i} \qquad ( 4 )$$

where γᵢ are the SINR values corresponding to the plurality of subcarriers. Another example is to use a statistical aspect of the γᵢ, such as the median value. In another embodiment, SINR_{band} can optionally be averaged over both frequencies (e.g., subcarriers) and time periods (e.g., OFDM symbol periods), which can be useful at high Doppler if a codeword will span multiple symbol periods, or if the EESM method is being used to support slow link adaptation. In the case of slow link adaptation, it is useful to define and use SINR_{band} as a statistical SINR indicator, such as the SINR averaged or filtered over a significant time period, or such as a particular point on a probability distribution function (PDF) or cumulative distribution function (CDF) of the band-average SINR over many time instants.

At step 306, the band-average SINR (SINR_{band}) is translated to a translated effective SINR for a β value. The translation is used to improve the accuracy of MCS selection, since SINR_{band} does not provide an accurate indication of the best MCS for the current channel condition in many delay spread channel conditions for an OFDM system. The translation is based on a third function of at least the band-average SINR and the set of characteristic parameters. In one embodiment of the present invention, the SS 104 transmits the SINR_{band} and the set of characteristic parameters to the BS 102. For this purpose, the set of characteristic parameters are determined using a reference SINR (SINR_{ref}) value. In an embodiment of the present invention, the value of the SINR_{ref} is already known to the BS 102 and the SS 104. In this embodiment, the SS 104 scales the SINR values of each subcarrier of the carrier channel by a value ‘q’, such that the value of the SINR_{band} becomes equal to that of the SINR_{ref}. The SS 104 then determines the set of characteristic parameters to be transmitted to the BS 102 for the first function. After transmitting the set of characteristic parameters, the SS 104 sends the SINR_{band} values (e.g., once per frame or at some other interval), without scaling, to the BS 102. The BS 102 can then determine a translated effective SINR at any desired β value for each SINR_{band} that is received (obtained) from the SS 104 based on the third function. The third function is preferably of the form:
SINR_{eff}(SINR_{band},β)=SINR_{band}/SINR_{ref}×SINR_{eff}(SINR_{ref},β′) (5)
where β′=β×SINR_{ref}/SINR_{band}
and where SINR_{eff} (SINR_{band},β) is the translated effective SINR value.
In other words, the translated effective SINR value is obtained by applying the third function to the curve obtained using the set of characteristic parameters. In one embodiment, for the translation, the values of the SINR_{band} and the SINR_{ref} are used. SINR_{ref} is a reference band-average SINR value associated with or corresponding to the characteristic parameters.

In an embodiment of the present invention, the SINR_{band} is determined by the SS 104 using the pilots of the subcarriers. There is a predetermined difference in the power between the pilots and the data-carrying subcarriers of the plurality of subcarriers of the carrier channel. The SINR_{band} is determined by transforming the SINR of the pilots to the SINR for the data carrying subcarriers.

At step 308, the MCS value is selected (e.g., at the BS 102), based on the translated effective SINR, as described earlier in conjunction with FIG. 2. In one embodiment, after selecting the MCS, data is modulated and coded based on the selected MCS and is then transmitted.

As described in FIG. 3 and FIG. 4, the SS 104 may transmit the set of characteristic parameters to the BS 102. In another embodiment, the set of characteristic parameters may be obtained by the BS 102 by observing uplink transmissions, such as uplink data transmissions, from the SS 104. This is especially applicable to systems with time division duplexing of uplink and downlink transmission, but may also be applied to systems with frequency division duplexing of uplink and downlink transmissions. This is applicable to frequency division duplex systems as well since the multipath power-delay profile (and hence the multipath delay spread and channel type) is substantially the same on the uplink and on the downlink.

FIG. 4 is a flow chart for a method in accordance with the present invention for assisting modulation and coding scheme (MCS) selection for at least a portion of a carrier channel, the carrier channel comprising a plurality of subcarriers. At step 402, a set of characteristic parameters is determined for a first function representing a variation of an effective SINR of the carrier channel with a calibration parameter. The set of characteristic parameters is computed based on a plurality of measurements of the carrier channel, preferably at different time instances. At step 404 the set of characteristic parameters is transmitted to a second communication unit. At step 406, an effective SINR for a reference calibration parameter is transmitted to the second communication unit to assist with MCS selection by the second communication unit.

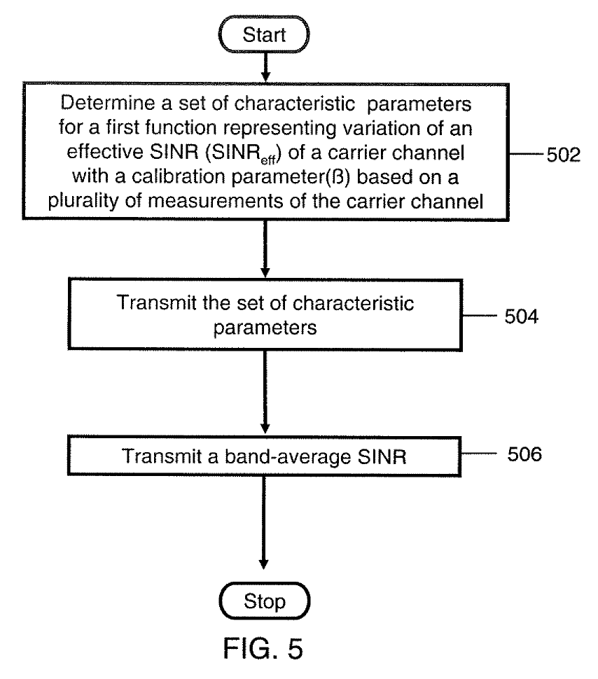

FIG. 5 is a flow chart for an additional method in accordance with the present invention for assisting modulation and coding scheme (MCS) selection for at least a portion of a carrier channel, the carrier channel comprising a plurality of subcarriers. At step 502, a set of characteristic parameters is determined for a first function representing a variation of an effective SINR of the carrier channel with a calibration parameter. The set of characteristic parameters is computed based on a plurality of measurements of the carrier channel, preferably at different time instances. At step 504 the set of characteristic parameters is transmitted to a second communication unit. At step 506, a band-average SINR is transmitted to the second communication unit to assist with MCS selection by the second communication unit.

Determining the set of characteristic parameters in the methods of FIG. 4 and FIG. 5 may further comprise selecting a set of characteristic parameters associated with one of the plurality of measurements of the carrier channel at different time instances, or computing an ensemble average set of characteristic parameters from the plurality of measurements of the carrier channel at different time instances (e.g., as described earlier in conjunction with other embodiments). The measurement of the carrier channel in the methods of FIG. 4 and FIG. 5 may further comprise determining SINR values for a plurality of subcarriers within the carrier channel.

In the method of FIG. 5, the set of characteristic parameters may further be computed based on a reference band-average SINR value (e.g., as described earlier in conjunction with other embodiments).

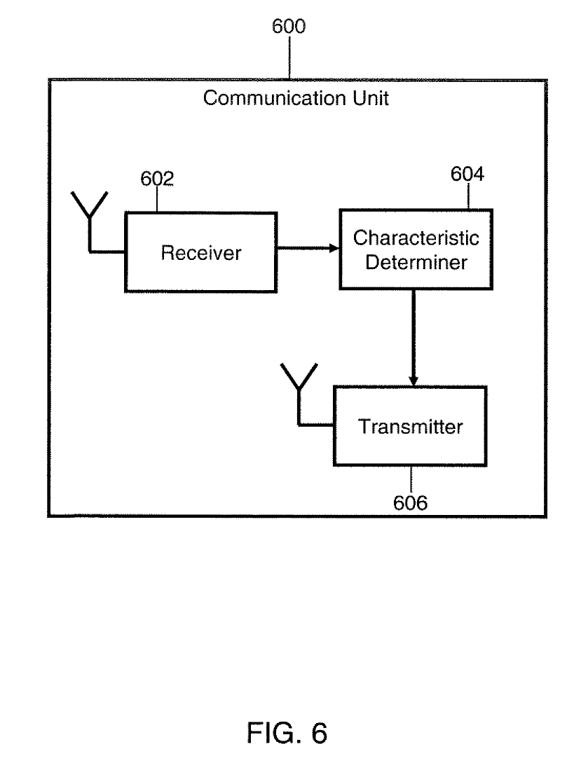

FIG. 6 is a block diagram of a communication unit 600 (e.g., the SS 104), in accordance with an embodiment of the present invention. The communication unit 600 includes a receiver 602, a characteristic determiner 604, a transmitter 606 and a memory 608. The receiver 602 is capable of determining SINR values for a plurality of subcarriers, and is capable of determining at least one of the effective SINR (SINR_{eff}) for a reference calibration parameter value (β_{ref}) and a band-average SINR (SINR_{band}). The effective SINR can be computed using the EESM method, as described earlier in conjunction with FIG. 2. Other frequency selective link error prediction methods may be used to determine an effective SINR, such as such as Mutual Information Effective SINR Mapping (MIESM) or Capacity Effective SINR Mapping (CESM). The band-average SINR represents an average of SINR values for a plurality of subcarriers of the carrier channel, as described earlier in conjunction with FIG. 2. The characteristic determiner 604 is capable of determining a set of characteristic parameters for a first function based on a variation of an effective SINR of the carrier channel with a calibration parameter. The method of selecting the set of characteristic parameters is explained in detail in conjunction with FIG. 2. The characteristic determiner 604 further computes the variation of the SINR_{eff} with the β. Moreover, the characteristic determiner 604 selects the set of characteristic parameters for the first function that represent the variation of the SINR_{eff} with the β, as described earlier in conjunction with FIG. 2. The transmitter 606 is capable of transmitting the set of characteristic parameters to another communication unit (e.g., the BS 102). In an embodiment of the present invention, the transmitter 606 also transmits the effective SINR (SINR_{eff}) for a reference calibration parameter value (β_{ref}). In another embodiment of the present invention, the transmitter 606 transmits the value of the band-average SINR (SINR_{band}). The transmitter may transmit a new SINR_{eff} once per frame and the set of characteristic parameters once every several frames. The transmission interval can be changed based on channel conditions or other factors.

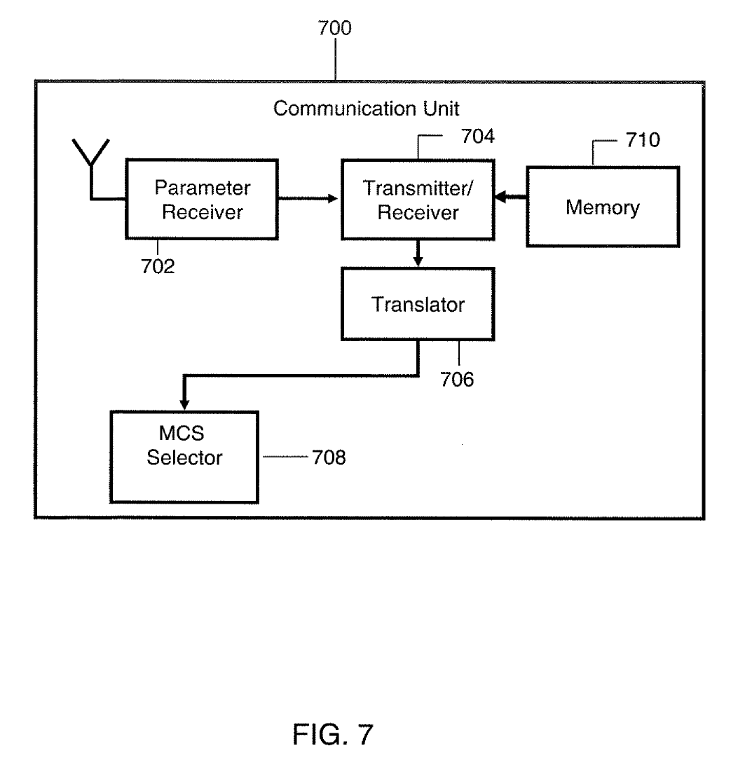

FIG. 7 is an exemplary block diagram of a communication unit 700 (e.g., the BS 102), in accordance with an embodiment of the present invention. The communication unit includes a parameter receiver 702, a transmitter/receiver 704, a translator 706, MCS selector 708 and a memory 710. The parameter receiver 702 is configured to obtain a set of characteristic parameters for a first function representing a variation of an effective SINR of the carrier channel with a calibration parameter. In an embodiment, the set of characteristic parameters is based on at least one of predefined and measured characteristics of the carrier channel, as described earlier. The transmitter/receiver 704 is capable of obtaining the effective SINR for the reference calibration parameter value. In another embodiment, the transmitter/receiver 704 is capable of obtaining a band-average SINR. The band-average SINR represents an average of SINR values for a plurality of subcarriers within the carrier channel. In an embodiment, the translator 706 is capable of translating the effective SINR for the reference calibration parameter value to a translated effective SINR for a calibration parameter value that differs from the reference calibration parameter value based on the second function. The second function is equivalent to (or characterized by) a two-dimensionally shifted version of the first function when viewed in a log domain. The output of the second function is substantially close to the effective SINR for the reference calibration parameter value when the input to the second function is the reference calibration parameter value. In another embodiment, the translator 706 is capable of translating the band-average SINR to a translated effective SINR for a particular calibration parameter value based on a third function of at least the band-average SINR and the characteristic parameters. The MCS selector 708 is capable of selecting an MCS from a predefined MCS set for at least a portion of the carrier channel based on the translated effective SINR. The memory 710 stores one or more sets of characteristic parameters, such as for one or more predefined channel conditions in one embodiment, or for the characteristic parameters that have previously been obtained in another embodiment. The set of characteristic parameters can be sent from the memory 710 to the transmitter/receiver 704. In one embodiment, transmitter/receiver 704 is also capable of modulating and coding data based on selected MCS, and of transmitting the data that is modulated/coded based on the selected MCS.

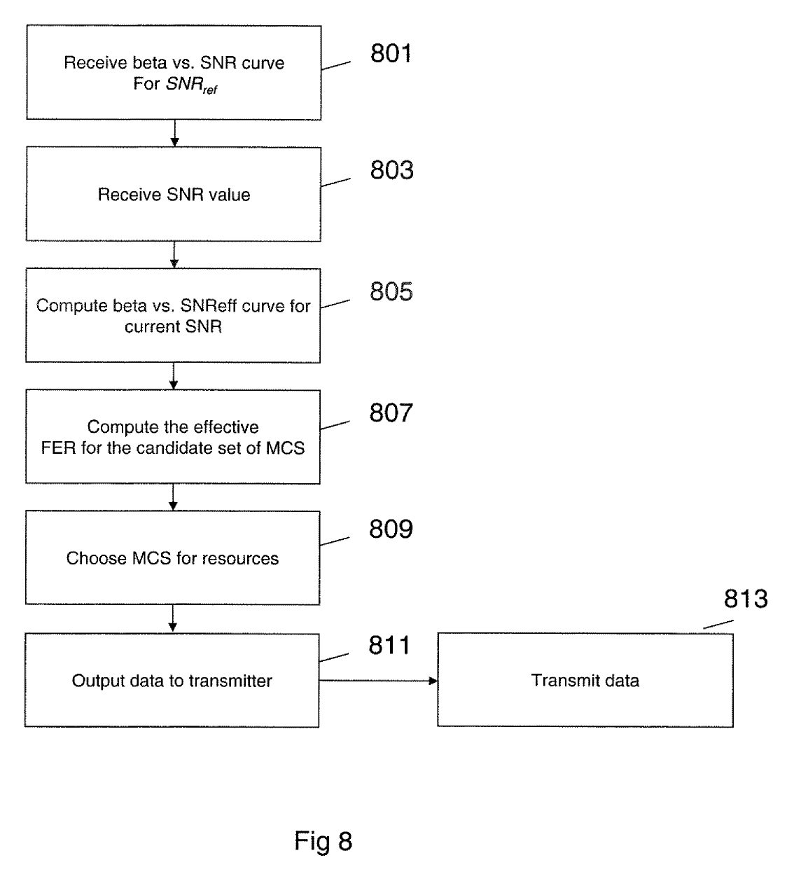

FIG. 8. shows a flow chart for transmitting data from a communication unit 102 using the method for MCS selection described in FIG. 3 for fast Adaptive Modulation and Coding (AMC), wherein fast AMC consists in selecting an appropriate MCS for the transmission. The logic flow begins at step 801 where the parameter receiver 702—receives a SNR_{eff} vs. β curve, wherein SNR_{eff} vs. β curve is the set of characteristic parameters for a first function, where the first function represents a variation of the SINR_{eff} of the carrier channel with the β. At step 803, transmitter/receiver 704 receives an SNR value from communication unit 104 indicating a current SNR. The SNR may be a band average SNR value. At step 805, translator 706 computes the SNR_{eff} vs. β curve based on the reference curve sent at step 801 and the SNR value sent at step 803 using equation (3). At step 807 MCS selector 708 computes the SNR_{eff}, which relates to Frame Error Rate (FER), for a plurality candidate MCS schemes by figuring SNR_{eff} for the β value associated to a given MCS using the SNR_{eff} vs. β curve computed at step 1205. The candidate MCS scheme may be all or a subset of the available MCS schemes. Alternatively, interpolation techniques can be used to compute the expected FER for some MCSs. The MCS utilized is chosen at step 809 based on the expected FER values In particular, the MCS that has the highest possible throughput with an expected FER lower than a target value (typically 10⁻¹) is typically chosen. At step 811 the data stream is modulated and coded, and the data stream is transmitted at step 813.

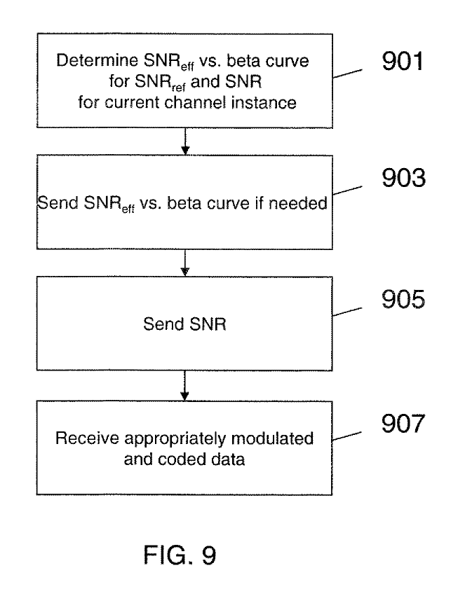

FIG. 9 is a flow chart showing operation of communication unit 104 for fast AMC. The logic flow begins at step 901 where the SNR_{eff} vs. β curve is determined by characteristic determiner 604 along with the current SNR for the current channel instance and a reference SNR value. This is accompilished by analyzing SNR values at the receiver 602. At step 903 the SNR_{eff} vs. β curve for the current channel is compared by characteristic determiner 604 with the previously sent SNR_{eff} vs. β curve that is currently used by communication unit 102. If the curve for the current channel is different enough than the previously sent curve (e.g., if the least square error is greater than 2 dB over a pre-determined range of β values), the parameters representing the SNR vs. β curve are reported to the transmitter. At step 905, the SNR is reported to communication unit 102 via transmitter 606. Finally, at step 907 data is received modulated and coded with the appropriate MCS.

Embodiments of the present invention, for selecting the MCS for the multi-carrier channel, enable the accurate determination of the MCS. Further, the method for selecting the MCS for the multi-carrier channel saves overhead charges of transmission. This is because only a small number of parameters are required to be transmitted to implement the method. Further, embodiments of the present invention provide a simple method to determine the SINR_{eff} from characteristics of the previous frames, which accounts for a scaling in the values of the SINR of individual subcarriers of the carrier channel.

It will be appreciated the modules described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method to select the MCS for a multi carrier system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for selecting a modulation and coding scheme (MCS) at a communication unit, for at least a portion of a carrier channel comprising a plurality of subcarriers, the method comprising:
obtaining a set of characteristic parameters for a first function representing a variation of an effective signal to noise-plus-interference ratio (SINR) of the carrier channel with a calibration parameter, wherein the set of characteristic parameters is based on at least one of a predefined condition and measured condition of the carrier channel;
obtaining an effective SINR for a reference calibration parameter value;
translating the effective SINR for the reference calibration parameter value to a translated effective SINR for the calibration parameter value that differs from the reference calibration parameter value, based on a second function, wherein the second function is a two-dimensionally shifted version of the first function when viewed in a log domain;
and
selecting an MCS from a predefined MCS set for at least a portion of the carrier channel based on at least the translated effective SINR.

2. The method of claim 1, wherein obtaining the set of characteristic parameters comprises retrieving a set of characteristic parameters from a memory wherein the memory contains one or more predetermined sets of characteristic parameters.

3. The method of claim 1, wherein obtaining the set of characteristic parameters comprises receiving the set of characteristic parameters from a second communication unit.

4. The method of claim 1, wherein obtaining the effective SINR comprises receiving the effective SINR from a second communication unit.

5. The method of claim 1 wherein the characteristic parameters are based on at least one of: a selected one of a plurality of measurements of the carrier channel, and an average characteristic for a plurality of measurements of the carrier channel.

6. The method of claim 1, wherein the measured condition of the carrier channel comprises SINR values for a plurality of subcarriers within the carrier channel.

7. The method of claim 1 wherein the second function is further characterized by shifts of substantially similar magnitudes of the first function in each of the two dimensions when viewed in the log domain.

8. The method of claim 1 wherein the second function is further characterized by the output of the second function being substantially close to the effective SINR for the reference calibration parameter value when the input to the second function is the reference calibration parameter value.

9. The method of claim 1, wherein the reference calibration parameter value lies between a first calibration parameter value associated with a first MCS of the predefined MCS set, and a second calibration parameter value associated with a second MCS of the predefined MCS set.

10. A method for selecting a modulation and coding scheme (MCS) at a communication unit, for at least a portion of a carrier channel comprising a plurality of subcarriers, the method comprising:
obtaining a set of characteristic parameters for a first function representing a variation of an effective signal to noise-plus-interference ratio (SINR) of the carrier channel with a calibration parameter, wherein the set of characteristic parameters is based on at least one of predefined condition and measured condition of the carrier channel;
obtaining a band-average SINR, wherein the band-average SINR represents an average of SINR values for a plurality of subcarriers within the carrier channel;
translating the band-average SINR to a translated effective SINR for a calibration parameter value based on a third function of at least the band-average SINR and the set of characteristic parameters; and
selecting an MCS from a predefined MCS set for at least a portion of the carrier channel based on at least the translated effective SINR.

11. The method of claim 10, wherein obtaining the set of characteristic parameters comprises retrieving a set of characteristic parameters from a memory, wherein the memory contains one or more predetermined sets of characteristic parameters.

12. The method of claim 10, wherein obtaining the set of characteristic parameters comprises receiving the set of characteristic parameters from a second communication unit.

13. The method of claim 10, wherein obtaining the effective SINR comprises receiving the effective SINR from a second communication unit.

14. The method of claim 10 wherein the characteristic parameters are based on at least one of: a selected one of a plurality of measurements of the carrier channel, and an average characteristic for a plurality of measurements of the carrier channel.

15. The method of claim 10, wherein the measured condition of the carrier channel comprises SINR values for a plurality of subcarriers within the carrier channel.

16. The method of claim 10, wherein translating the band-average SINR to a translated effective SINR is further based on a reference band-average SINR value associated with the characteristic parameters.

17. A method for assisting modulation and coding scheme (MCS) selection for at least a portion of a carrier channel, the carrier channel comprising a plurality of subcarriers, the method comprising:
determining a set of characteristic parameters for a first function representing a variation of an effective SINR of the carrier channel with a calibration parameter, wherein the set of characteristic parameters is computed based on a plurality of measurements of the carrier channel at different time instances; and
transmitting the set of characteristic parameters to a second communication unit; and
transmitting at least one of an effective SINR for a reference calibration parameter value and a band-average SINR to the second communication unit to assist with MCS selection by the second communication unit.

18. The method of claim 17, wherein determining the set of characteristic parameters comprises selecting a set of characteristic parameters associated with one of the plurality of measurements of the carrier channel at different time instances.

19. The method of claim 17, wherein determining the set of characteristic parameters comprises computing an ensemble average set of characteristic parameters from the plurality of measurements of the carrier channel at different time instances.

20. The method of claim 17, wherein the set of characteristic parameters is computed based on a reference band-average SINR value.

21. The method of claim 17, wherein a measurement of the carrier channel comprises determining SINR values for a plurality of subcarriers within the carrier channel.

22. A communication unit for selecting a modulation and coding scheme (MCS) for at least a portion of a carrier channel comprising a plurality of subcarriers, the communication unit comprising:
a parameter receiver capable of obtaining a set of characteristic parameters for a first function representing a variation of an effective SINR of the carrier channel with a calibration parameter, wherein the set of characteristic parameters is based on at least one of predefined and measured characteristics of the carrier channel;
a receiver capable of obtaining at least one of the effective SINR for a reference calibration parameter value and a band-average SINR, wherein the band-average SINR represents an average of SINR values for a plurality of subcarriers within the carrier channel
a translator capable of at least one of:
translating the effective SINR for the reference calibration parameter value to a translated effective SINR for a calibration parameter value that differs from the reference calibration parameter value based on a second function, wherein the second function is a two-dimensionally shifted version of the first function when viewed in a log domain; and
translating the band-average SINR to a translated effective SINR for a calibration parameter value based on a third function of at least the band-average SINR and the characteristic parameters; and
a MCS selector capable of selecting an MCS from a predefined MCS set for the at least portion of the carrier channel based on at least the translated effective SINR.

23. The communication unit of claim 22 further comprising a memory, wherein the memory stores the set of characteristic parameters for one or more predefined channel conditions

24. A communication unit for transmitting information to assist modulation and coding scheme (MCS) selection for at least a portion of a carrier channel, the carrier channel comprising a plurality of subcarriers, the communication unit comprising:
a receiver capable of determining SINR values for a plurality of subcarriers of the carrier channel and capable of determining at least one of the effective SINR for a reference calibration parameter value and a band-average SINR, wherein the band-average SINR represents an average of SINR values for a plurality of subcarriers of the carrier channel;
a characteristic determiner capable of determining a set of characteristic parameters for a first function based on a variation of an effective SINR of the carrier channel with a calibration parameter, wherein the set of characteristic parameters is computed based on a plurality of measurements of the carrier channel at different time instances; and
a transmitter capable of transmitting the set of characteristic parameters, and at least one of the effective SINR for the reference calibration parameter value and the band-average SINR.
